(19) United States
(12) Patent Application Publication
(10) Pub. No.: US 2013/0175464 A1
(43) Pub. Date: Jul. 11, 2013

(54) GRIPPING MECHANISM FOR A GAS TANK VALVE

(71) Applicant: Steve Smith, Fullerton, CA (US)

(72) Inventor: Steve Smith, Fullerton, CA (US)

(21) Appl. No.: 13/736,629

(22) Filed: Jan. 8, 2013

Related U.S. Application Data
(60) Provisional application No. 61/585,357, filed on Jan. 11, 2012.

(51) Int. Cl. F16K 31/60

(52) U.S. Cl. CPC F16K 31/60
USPC 251/213

(57) ABSTRACT

A gripping mechanism for a gas tank utility valve is provided. The mechanism has a top portion and a bottom portion. The top portion provides a grip that allows for hand-tightening of the valve and the bottom portion is formed to include at least one cavity that receives the knob attached to the utility valve in a relatively tight-fit fashion.

### CROSS-REFERENCE TO RELATED APPLICATIONS

Pursuant to 35 U.S.C. 119(e), the present Application claims priority to Provisional Application Ser. No. 61585357, filed on Jan. 11, 2012, the content of which is incorporated by reference herein in its entirety.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to the use of a valve installed on a container and, more particularly, to a gripping mechanism for a gas tank utility valve.

### BACKGROUND

Currently available non-commercial propane gas tanks have a utility valve installed on the top of the tank that is used to control the flow of the pressurized gas as it exits the tank during use. The knob attached to the valve is small to the grip and when tightened can be very difficult to undo. If over-tightened (especially if the gas tank is located in an out-of-reach area, such as under a barbeque grill), the user may have to move the heavy tank and apply a common wrench or tool to open the valve. Such tools are generally unsuitable for this particular purpose and can result in damage to the knob or can even break it off, if too much pressure is applied, causing inconvenience and potentially a dangerous situation.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one or more embodiments, a gripping mechanism for a gas tank utility valve is provided. The mechanism has a top portion and a bottom portion. The top portion provides a grip that allows for hand-tightening of the valve and the bottom portion is formed to include a cavity that receives the knob attached to the utility valve in a relatively tight-fit fashion.

In accordance with one embodiment, an apparatus for rotating a knob is provided, wherein the apparatus comprises a top portion and a bottom portion, wherein the top portion provides a grip that allows for the tightening or loosening of the a valve attached to the knob and the bottom portion is formed to include at least one cavity that receives the knob in a relatively tight-fit fashion.

In one embodiment, the valve is a pressure valve utilized to control volume of gas exiting a closed container connected to the pressure valve. The container may be a gas tank utilized for providing propane gas to outdoor cooking grills. The at least one cavity formed in the bottom portion may be injection molded to fit a knob design commonly fitted to a gas tank utilized for providing propane gas to outdoor cooking grills.

The top portion may be engaged by a user to cause the knob to rotate as a result of the user applying rotational force to the handle. In one embodiment, the top portion may include a handle that is engaged by a user to cause the knob to rotate as a result of the user applying rotational force to the handle. Alternatively, or in addition to the handle, the top portion may include a ridged area that is engaged by a user to cause the knob to rotate as a result of the user applying rotational force to the handle.

In one embodiment, circumference of the top portion is larger than circumference of the knob. The circumference of the top portion is substantially larger than circumference of the knob to allow a user to hand-tighten a valve attached to the knob without significant effort. In one example embodiment, the circumference of the top portion is at least 1.5 times of the circumference of the knob.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 is a planar top view of an example gripping mechanism, in accordance with one embodiment.

FIG. 2 is a planar bottom view of the example gripping mechanism illustrated in FIG. 1, in accordance with one embodiment.

FIG. 3 is a perspective top view of an example gripping mechanism, in accordance with one embodiment.

FIG. 4 is a perspective bottom view of the example gripping mechanism illustrated in FIG. 3, in accordance with one embodiment.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

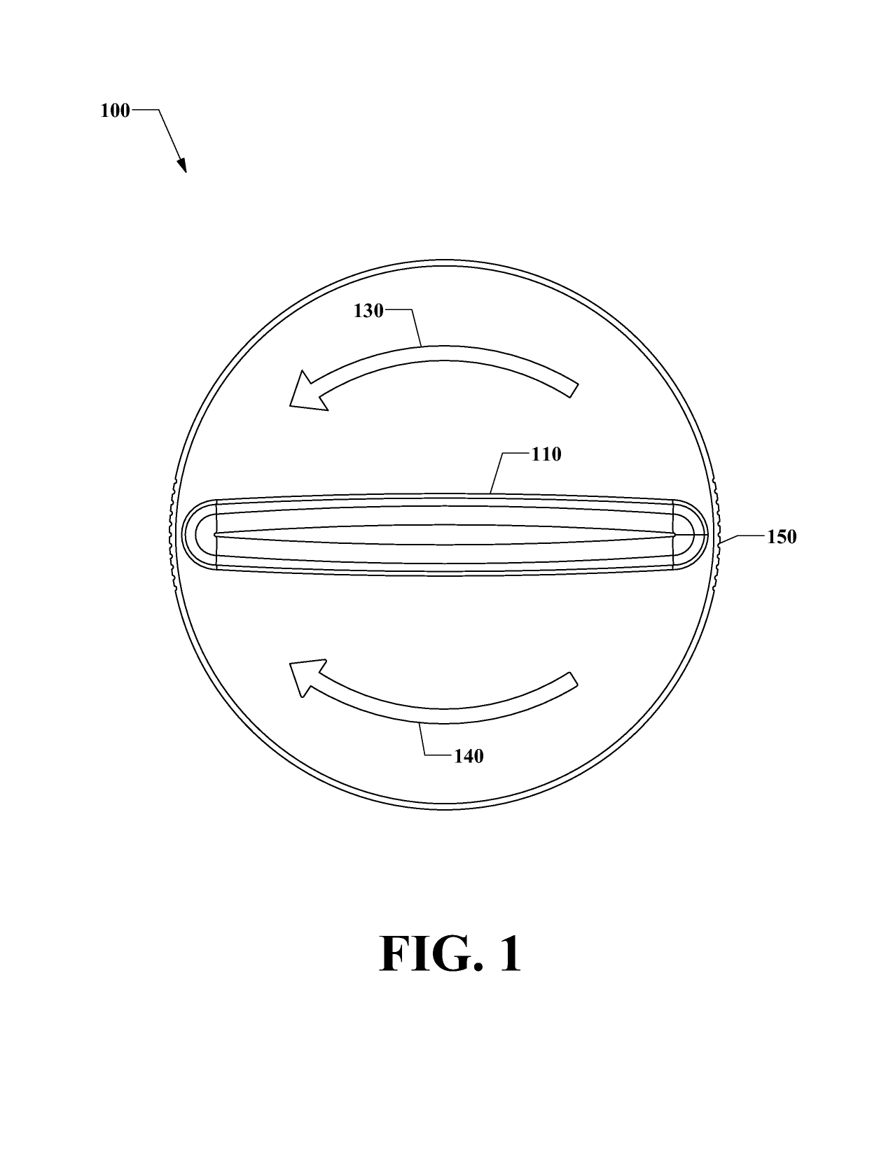

Referring to FIGS. 1 through 4, in accordance with one or more embodiments, a gripping mechanism 100 is provided that fits the top portion of a valve knob (not shown) for a propane gas tank, for example. The gripping mechanism 100 has top and bottom portions, wherein the bottom portion is utilized to engage the valve knob and the top portion is designed to help a human operator easily apply pressure to the knob to open or shut the valve without the use of any other utility tools.

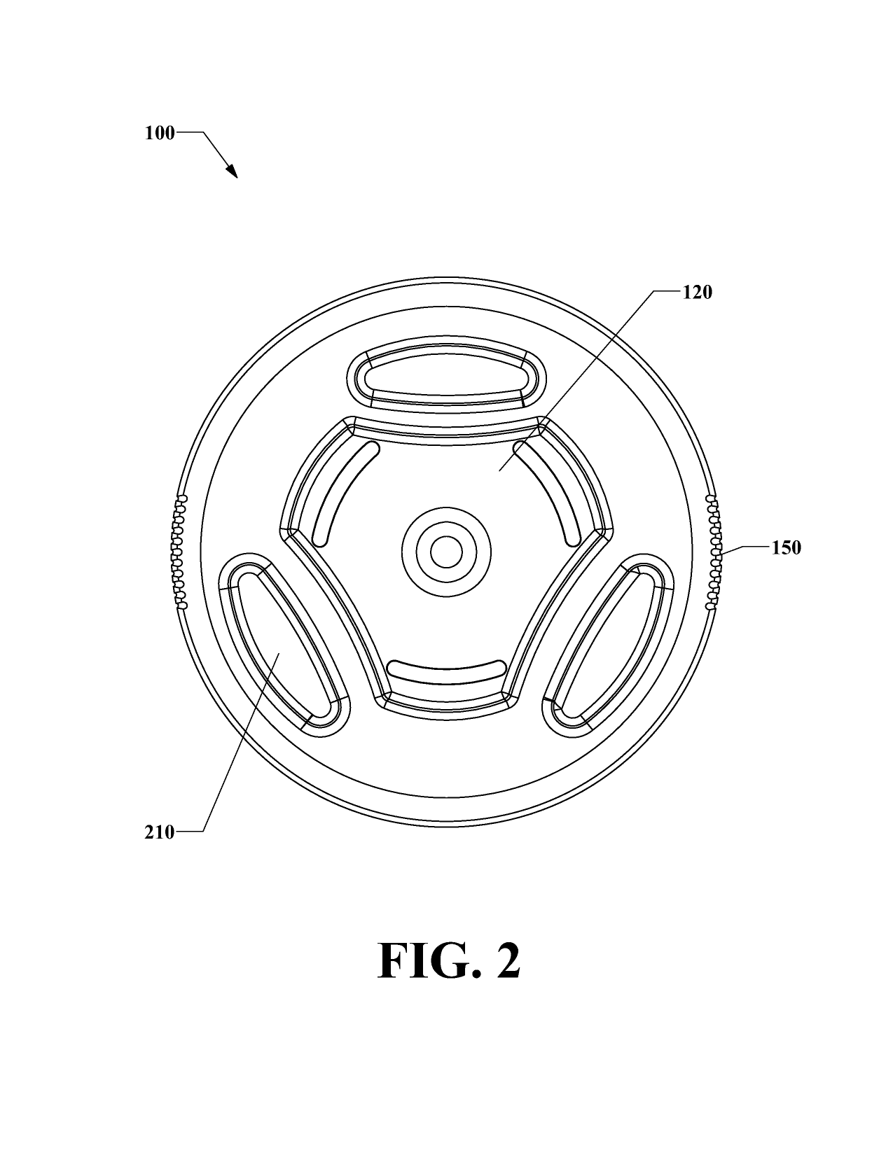

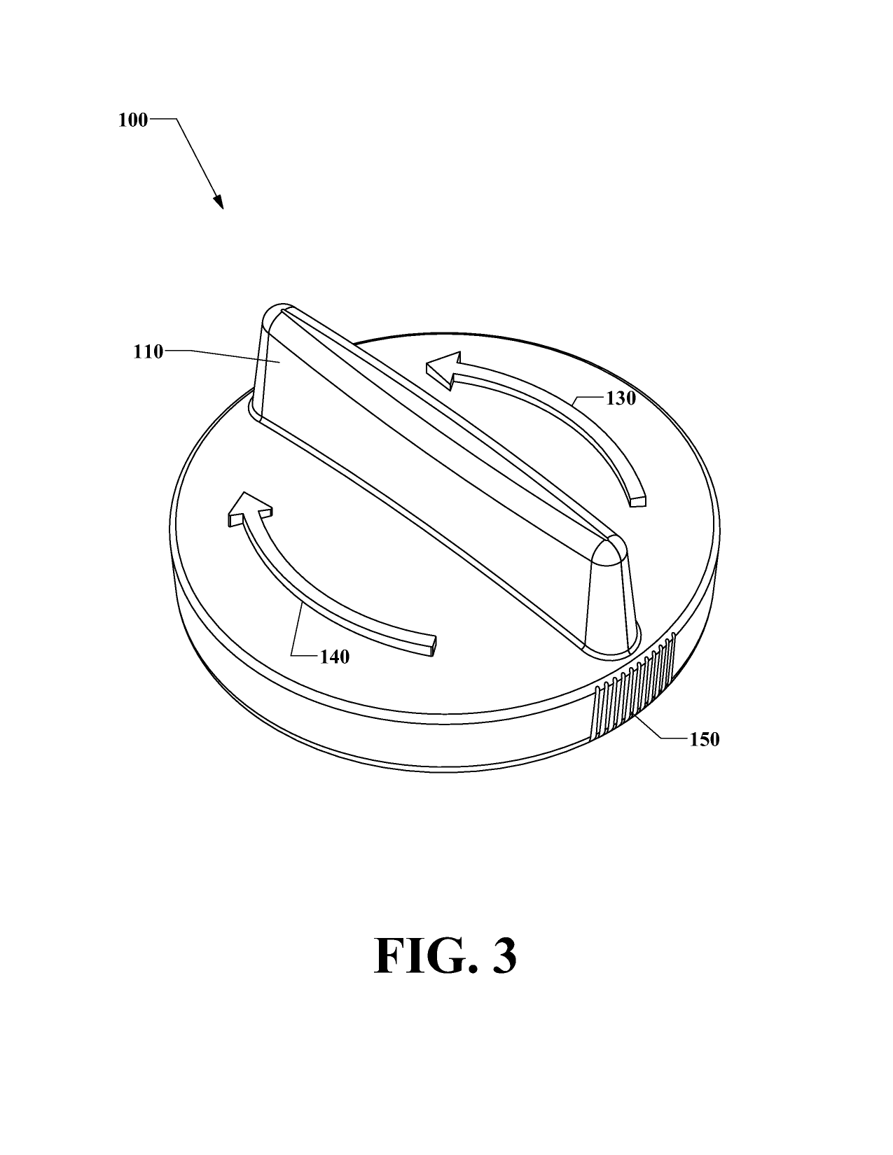

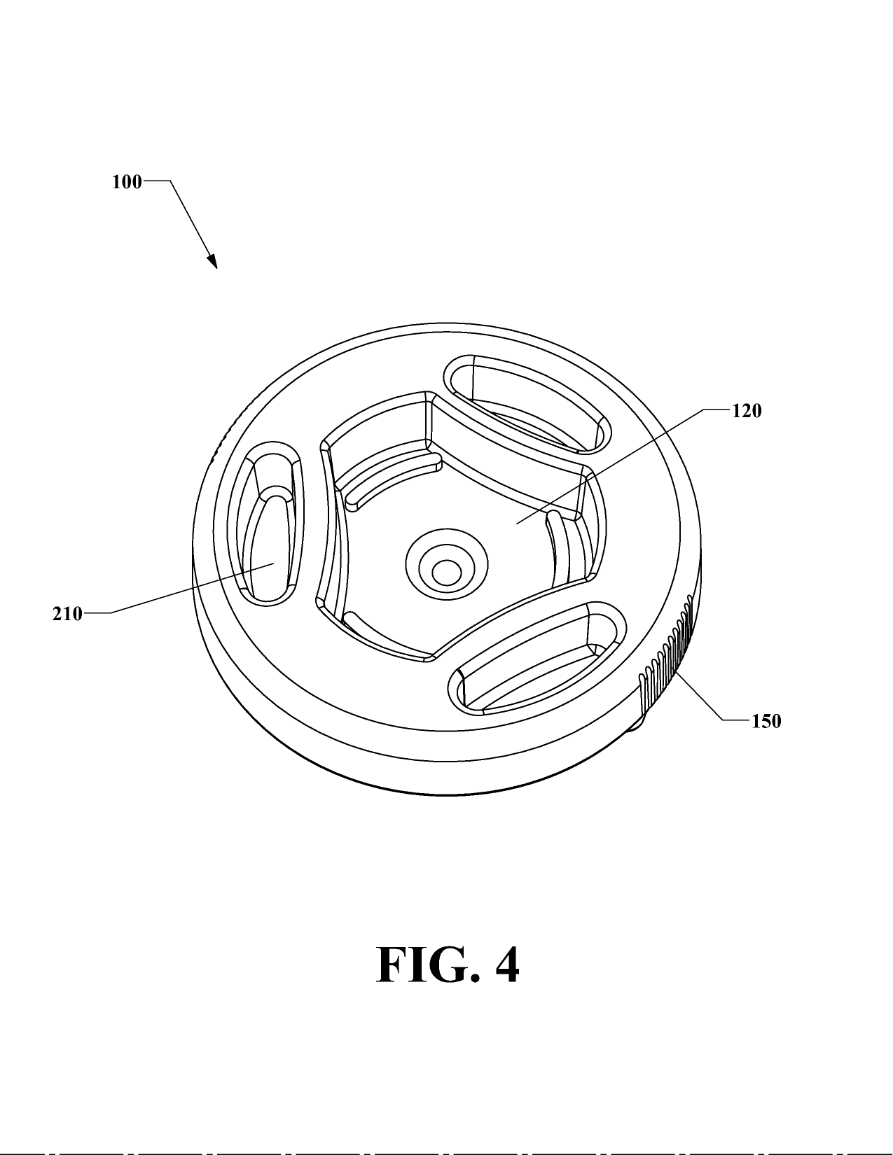

The top portion of the gripping mechanism 100 may include a handle 110 (e.g., in form of a protruding edge, or in the shape of a cross) that allows a user to finger or hand-tighten the valve by way of applying pressure to the gripping mechanism 100 in clock-wise or counter clock-wise directions (see directional arrows 130 and 140 in FIGS. 1 and 3). The pressure applied to the top portion of the gripping mechanism 100 is transferred to the valve knob, which may be securely engaged inside at least one cavity 120 formed in the bottom portion of the gripping mechanism 100 (see FIGS. 2 and 4).

In addition, or in exchange for the handle 110, the gripping mechanism 100 may have a corrugated portion or perimeter area 150, optionally forming ridges that extend or are positioned on the circumferential area of the gripping mechanism 100, as shown in the figures. The ridges provide for a better grip and may prevent the user's hand or fingers from slipping, if a certain (e.g., substantial) amount of force needs to be applied to rotate the gripping mechanism 100. In one embodiment, size of the circumference of the gripping mechanism 100 is at least 1.5 times the circumference of the knob to provide for sufficient leverage.

The circumferential shape of the gripping mechanism 100 may be circular, for example, as shown in the figures. In some embodiments, the overall shape of the gripping mechanism 100 may be different however. For example, the gripping mechanism 100 may be shaped in the form of a square, a rectangle, a triangle, an elipse or other shape that would be functionally useful and would allow a user to easily grip the gripping mechanism 100 either by way of the handle 110 or the circumferential edges of the mechanism itself The shape of the handle 110 may also vary depending on implementation.

Referring to FIGS. 2 and 4, the bottom portion of the gripping mechanism 100 may comprise one or more grooves or cavities 120 that are configured to receive a valve knob in a secure manner, so that a user may tighten or loosen the valve by applying pressure to the top portion of the gripping mechanism 100 in a rotational manner. In one embodiment, the one or more cavities 120 and grooves in the bottom portion are designed to correspond in a male-female arrangement to the contours and shape of the valve knob for a relatively tight fit.

As such, the gripping mechanism 100 is configured to simplify the manner in which a user loosens or tightens a valve by way of providing one or more cavities 120 that are shaped to receive and fit a valve knob. In one example embodiment, the one or more cavities 120 are shaped to form a depressed triangle with rounded vertices and concaved edges, as shown in FIG. 2, for example. The circumferential shape of the gripping mechanism 100 is configured to provide an easy and comfortable way for hand pressure to be applied to the valve knob without the user hurting his hand or over-tightening of the valve.

In one implementation, the shape of the handle 110 on the top of the gripping mechanism 100 makes the location where pressure is to be applied easy to locate and therefore makes loosening and tightening the valve a single-step process. Further, the gripping mechanism 100 provides a user with increased accessibility to a valve that may otherwise be inaccessible to tighten or loosen, for example, if the gas tank is located in an area that is not easily reachable. The ability to hand- or finger-tighten a valve also eliminates the possibility of over-tightening, as mentioned earlier.

Advantageously, the use of the gripping mechanism 100 disclosed here helps a user to apply just about the right amount of pressure to loosen or tighten a valve. In the case of a gas tank with a relatively small valve knob, users with big hands, in particular, may have a difficult time gripping the naked valve knob and as a result may under- or over-tighten the vale, especially if the valve is not readily accessible or visible. This situation may lead to the need to remove the gas tank in its entirety from its position in order to loosen the valve the next time the user requires the use of the gas tank.

Using the gripping mechanism 100 to tighten the valve, a user has more control over the amount of pressure being applied both in a rotational direction and also in a vertical direction over the valve knob. This extra level of control by itself is sufficient to prevent over- or under-tightening in most scenarios. Furthermore, with the use of the gripping mechanism 100, the need for applying valve grease to keep the valve rotation smooth may be eliminated—valve grease dries over time and may cause problems with the tightening and loosening of the valve.

Without limitation, depending on design and implementation and due to cost considerations, the material used to make the gripping mechanism 100 may vary. Exemplary types of material that may be used in the construct of the gripping mechanism 100 may include metals, metal alloys, composites of metals or alloys, as well as plastic, rubber elements or combinations thereof that are suitable for the intended use and purpose. In one embodiment, the gripping mechanism may be efficiently mass produced by way of injection molding, for example.

It is noteworthy that while the present disclosure has been provided by way of example as applicable to a gas tank with a valve knob that has a particular shape, in various embodiments, the subject matter claimed herein may be utilized to handle or engage any type of a knob, whether the knob is attached to a gas valve or not. In other words, the scope of the claimed subject matter shall not be construed as limited to examples provided in the specification or the figures and would broadly apply to any knob that is utilized for loosening, tightening, opening or closing functionalities.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. An apparatus for rotating a knob, the apparatus comprising:
a top portion and a bottom portion, wherein the top portion provides a grip that allows for tightening of the valve and the bottom portion is formed to include at least one cavity that receives the knob in a relatively tight-fit fashion.

2. The apparatus of claim 1, wherein the knob is attached to a valve.

3. The apparatus of claim 2, wherein the valve is a pressure valve utilized to control volume of gas exiting a closed container connected to the pressure valve.

4. The apparatus of claim 3, wherein the container is a gas tank utilized for providing propane gas to outdoor cooking grills.

5. The apparatus of claim 1, wherein the at least one cavity formed in the bottom portion is injection molded to fit a knob design commonly fitted to a gas tank utilized for providing propane gas to outdoor cooking grills.

6. The apparatus of claim 1, wherein the top portion includes a handle that is engaged by a user to cause the knob to rotate as a result of the user applying rotational force to the handle.

7. The apparatus of claim 1, wherein the top portion is engaged by a user to cause the knob to rotate as a result of the user applying rotational force to the handle.

8. The apparatus of claim 1, wherein the top portion includes a ridged area that is engaged by a user to cause the knob to rotate as a result of the user applying rotational force to the top portion.

9. The apparatus of claim 1, wherein circumference of the top portion is larger than circumference of the knob.

10. The apparatus of claim 1, wherein circumference of the top portion is substantially larger than circumference of the knob to allow a user to hand-tighten a valve attached to the knob without significant effort.
